(19) United States
(12) Patent Application Publication
(10) Pub. No.: US 2026/0186372 A1
(43) Pub. Date: Jul. 2, 2026

(54) Image Stabilization Driving Apparatus

(71) Applicant: AAC Acoustic Technologies (Shanghai) Co., Ltd., Shanghai (CN)

(72) Inventors: Nian Xiao, Shanghai (CN); Tongming Xu, Shanghai (CN); Aixin Xu, Shanghai (CN); Laiyu Luo, Shanghai (CN)

(21) Appl. No.: 19/333,361

(22) Filed: Sep. 19, 2025

Related U.S. Application Data
(63) Continuation of application No. PCT/CN2024/144354, filed on Dec. 31, 2024.

(51) Int. Cl. G03B 5/00; G02B 27/64

(52) U.S. Cl. CPC G03B 5/00; G02B 27/646; G03B 2205/0069

(57) ABSTRACT

Disclosed is an image stabilization driving apparatus, including an image stabilization static part, an image stabilization moving part movably supported at the image stabilization static part, coil groups, magnet groups, and drivers; an optical module being affixed to the image stabilization moving part; one of the coil groups and the magnet groups are affixed to the image stabilization static part, while the other one thereof are affixed to the image stabilization moving part; the magnet groups are positioned opposite and spaced apart from the coil groups; the coil groups and the magnet groups interact to produce an electromagnetic force to drive the image stabilization moving part to move; the drivers are mounted at the image stabilization static part and operable to control actuating directions of the coil groups. Compared with conventional technologies, the image stabilization driving apparatus can implement image stabilization and image stabilization correction.

### FIELD

The subject matter described herein relates to driving technologies, and more particularly relates to an image stabilization driving apparatus.

### BACKGROUND

Image stabilization is a widely adopted feature in a lens driver of various types of imaging devices to satisfy consumers'increasing demands on photography experience. Portable electronic devices such as smart phones, cameras, and computers integrated with a lens driver are more favored among the consumers.

In conventional technologies, an image stabilizer of a lens driver generally adopts an drive structure assembled by a coil and a magnet, where a support frame is supported on a base, and a lens tube mount is positioned in a central bore of the base, an actuating coil and an actuating magnet being affixed on the lens tube mount and the support frame, respectively; an OIS (optical image stabilization) coil is affixed to a housing and located above the support frame; and an OIS magnet is affixed to a side of the support frame distal from the base. When an electrical current is applied to the OIS coil, an electromagnetic field is created between the OIS coil and the OIS magnet, so that the OIS coil subjected to a Lorentz force generated by the electromagnetic field drives the OIS magnet to move in a direction perpendicular to an optical axis bringing the lens tube to move, whereby image stabilization is implemented.

However, due to using a single OIS coil and a single actuating magnet which create a magnetic field to drive each other, the image stabilization feature offered by traditional image stabilizers is functionally limited with an unsatisfactory stabilization effect; in addition, in a case that the mount positions of the OIS coil and the actuating magnet are offset from their predesigned positions, the image stabilization direction would deviate from the initially designed path.

Therefore, it is desirable to provide a novel image stabilization driving apparatus to solve the technical problems noted supra.

### SUMMARY

An image stabilization driving apparatus is described herein to implement image stabilization and image stabilization correction.

The image stabilization driving apparatus as described herein is configurable to drive an optical module to perform an image stabilization motion, the optical module having an optical axis, the image stabilization driving apparatus comprising an image stabilization static part, an image stabilization moving part movably supported on the image stabilization static part, coil groups, magnet groups, and drivers; the optical module being affixed to the image stabilization moving part; one of the coil groups and the magnet groups being affixed to the image stabilization static part while the other one thereof being affixed to the image stabilization moving part; the magnet groups being positioned opposite and spaced apart from the coil groups, the coil groups and the magnet groups interacting to generate an electromagnetic force driving the image stabilization moving part to move, the drivers being mounted at the image stabilization static part, the drivers being operable to control actuating directions of the coil groups, wherein:
the coil groups comprise a first coil group, a second coil group, and a third coil group, which are located in a same plane, the first coil group including at least two coils oppositely positioned in a spaced apart manner along a first direction, the second coil group and the third coil group each including at least two coils oppositely positioned in a spaced apart manner along a second direction, the second coil group being positioned opposite and spaced apart from the third coil group along the first direction, the first direction and the second direction being perpendicular to each other and both being perpendicular to the optical axis;
the magnet groups comprise a first magnet group positioned opposite and spaced apart from the first coil group, a second magnet group positioned opposite and spaced apart from the second coil group, and a third magnet group positioned opposite and apart from the third coil group;
the drivers comprise a first driver set corresponding to the coils in the first coil group, a second driver set corresponding to the coils in the second coil group, and a third driver set corresponding to the coils in the third coil group, the first driver being configurable to generate a first actuating signal to drive the first coil group and the first magnet group to interact to produce a first actuating force in the first direction driving the image stabilization moving part to move along the first direction, the second driver being configurable to generate a second actuating signal to drive the second coil group and the second magnet group to interact to produce a second actuating force, the third driver being configurable to generate a third actuating signal to drive the third coil group and the third magnet group to interact to produce a third actuating force, directions of the second actuating force and the third actuating force being angled to the direction of the first actuating force, the second actuating force and the third actuating force co-acting to drive the image stabilization moving part to move along the second direction, or the second actuating force and the third actuating force co-acting to drive the image stabilization moving part to rotate about the optical axis while moving along the second direction to implement image stabilization in the second direction.

In some embodiments, in a case that the second actuating force and the third actuating force extend in a same direction or the second actuating force and the third actuating force extend in opposite directions while their magnitudes are different, and directions of the second actuating force and the third actuating force being both perpendicular to the direction of the first actuating force, the second actuating force and the third actuating force co-act to drive the image stabilization moving part to move in the second direction.

In some embodiments, in a case that the second actuating force and the third actuating force extend in a same direction or the second actuating force and the third actuating force extend in opposite directions while their magnitudes are different, and directions of the second actuating force and the third actuating force extend at an acute angle relative to the direction of the first actuating force, the second actuating force and the third actuating force co-act to drive the image stabilization moving part to rotate about the optical axis to correct an image stabilization movement direction of the image stabilization driving apparatus so that the image stabilization moving part moves in the second direction.

In some embodiments, magnitudes and directions of actuating forces between different coils in a same coil group among the first coil group, the second coil group, and the third coil group are identical or different.

In some embodiments, distribution of magnetic poles of magnets in the second magnet groups corresponding to the second driver is opposite to distribution of magnetic poles of magnets in the third magnet group corresponding to the third driver.

In some embodiments, the second coil group includes a first actuating coil and a second actuating coil which are positioned at two opposite sides of the image stabilization static part along the second direction, respectively, and the third coil group includes a third actuating coil and a fourth actuating coil which are positioned at two opposite sides of the image stabilization static part along the second direction, respectively, the first actuating coil and the third actuating coil being located at a same side; the second magnet group includes a first magnet and a second magnet which are set corresponding to the first actuating coil and the second actuating coil, respectively, and the third magnet group includes a third magnet and a fourth magnet which are set corresponding to the third actuating coil and the fourth actuating coil, respectively;

the second driver is set in the first actuating coil or the second actuating coil, and the third driver is set in the third actuating coil or the fourth actuating coil.

In some embodiments, in a case that the second driver and the third driver are diagonally located, a magnetic pole of the first magnet is opposite to a magnetic pole of the third magnet, a magnetic pole of the third magnet is opposite to a magnetic pole of the fourth magnet, and the magnetic pole of the first magnet is identical to the magnetic pole of the third magnet.

In some embodiments, in a case that the second driver and the third driver are located at a same side, a magnetic pole of the first magnet is identical to a magnetic pole of the second magnet, a magnetic pole of the third magnet is identical to a magnetic pole of the fourth magnet, and the magnetic pole of the first magnet is opposite to the magnetic pole of the third magnet.

In some embodiments, the image stabilization static part comprises a base and a housing which is affixed to the base and defines an accommodation space together with the base, the image stabilization moving part comprises a support frame defining a receiving space, and the image stabilization driving apparatus further comprises a support member that suspends the support frame movably in the accommodation space, the optical module being affixed to the support frame, the coil groups and the magnet groups interact to drive the support frame to move.

Compared with conventional technologies, in the image stabilization driving apparatus according to the present disclosure, one of the coil groups and the magnet groups are affixed to the image stabilization static part, while the other one thereof are affixed to the image stabilization moving part, the magnet groups being positioned opposite and spaced apart from the coil groups, the coil groups and the magnet groups interacting to produce an electromagnetic force driving the coil groups or the magnet groups to move, the drivers being mounted to the image stabilization static part, the drivers being operable to control actuating directions of the coil groups; the second coil group being positioned opposite and spaced apart from the third coil group along the first direction; the first direction and the second direction are perpendicular to each other and they are both perpendicular to the optical axis; the first driver is operable to generate a first actuating signal to drive the first coil group and the first magnet group to interact to produce an actuating force in the first direction driving the image stabilization moving part to move along the first direction to perform image stabilization in the first direction, the second driver is operable to produce a second actuating signal to drive the second coil group and the second magnet group to interact to produce a second actuating force, and a third driver is operable to produce a third actuating signal to drive the third coil group and the third magnet group to interact to produce a third actuating force; directions of the second actuating force and the third actuating force are angled relative to the direction of the first actuating force; the second actuating force and the third actuating force co-act to drive the image stabilization moving part to move along the second direction to implement image stabilization in the second direction. Or, the second actuating force and the third actuating force co-act to drive the image stabilization moving part to rotate about the optical axis while moving along the second direction, which corrects movement of the image stabilization moving part offset from the initially designed path back to the second direction. This novel rotating image stabilization apparatus can realize image stabilization and image stabilization correction.

### BRIEF DESCRIPTION OF THE DRAWINGS

To illustrate the technical solutions in the embodiments of the disclosure more clearly, the drawings referred to in describing the embodiments will be introduced briefly. It is apparent that the drawings provided below are only some embodiments of the disclosure, and to those skilled in the art, other drawings may also be derived based on these drawings without exercise of inventive work, in which:

FIG. 1 is a structural schematic diagram of an image stabilization driving apparatus according to a first implementation of the present disclosure;

FIG. 2 is a stereoscopic structural exploded view of FIG. 1;

FIG. 3 is a sectional view along line A-A of FIG. 1;

FIG. 4 is a local exploded view of FIG. 2;

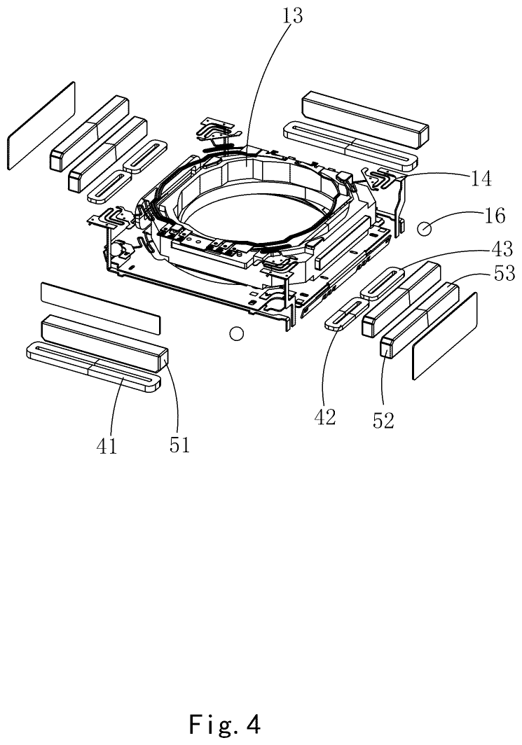

FIG. 5 is a structural schematic diagram of an image stabilization driving apparatus according to a second implementation of the present disclosure;

FIG. 6 is a stereoscopic structural exploded view of FIG. 5;

FIG. 7 is a sectional view along line B-B of FIG. 5;

FIG. 8 is an assembled structural schematic diagram of coil groups, magnet groups, and drives in the image stabilization driving apparatus according to some implementations of the present disclosure;

FIG. 9 is a structural schematic diagram of tractive forces of the image stabilization driving apparatus in a same direction according to some implementations of the present disclosure;

FIG. 10 is a structural schematic diagram of tractive forces of the image stabilization driving apparatus in different directions according to some implementations of the present disclosure;

FIG. 11 is a structural schematic diagram of the image stabilization driving apparatus with a second driver and a third driver being positioned at a same side according to some implementations of the present disclosure.

In the drawings: 100—image stabilization driving apparatus; 1—image stabilization static part, 11—base; 12—support frame; 121—frame body; 122—clearance recess; 13—holder; 14—elastic member; 15—housing; 16—support member; 2—optical filter; 3—image stabilization moving part; 4—coil group; 41—first coil group; 411—fifth actuating coil; 412—sixth actuating coil; 42—second coil group; 421—first actuating coil; 422—second actuating coil; 43—third coil group; 431—third actuating coil; 432—fourth actuating coil; 5—magnet group; 51—first magnet group; 511—fifth magnet; 512—sixth magnet; 52—second magnet group; 521—first magnet; 522—second magnet; 53—third magnet group; 531—third magnet; 532—fourth magnet; 6—drivers; 61—first drive; 62—second drive; 63—third drive; 7—image sensor.

### DETAILED DESCRIPTION OF EMBODIMENTS

Hereinafter, the technical solutions in the embodiments of the disclosure will be described in a clear and comprehensive manner with reference to the accompanying drawings. It is noted that, the example implementations described herein are only examples of the embodiments of the disclosure. All other implementations derived by a person of normal skill in the art based on these example implements without exercise of inventive work would fall within the scope of protection of the embodiments of the disclosure.

### First Implementation

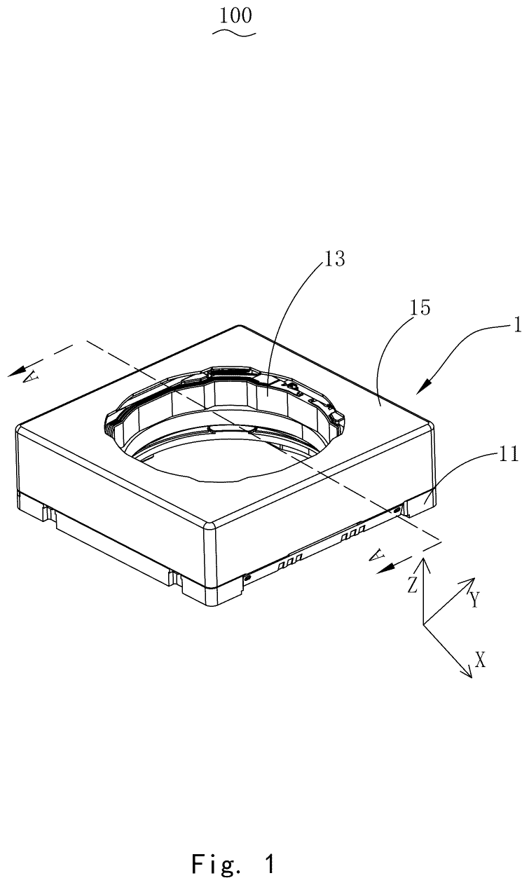

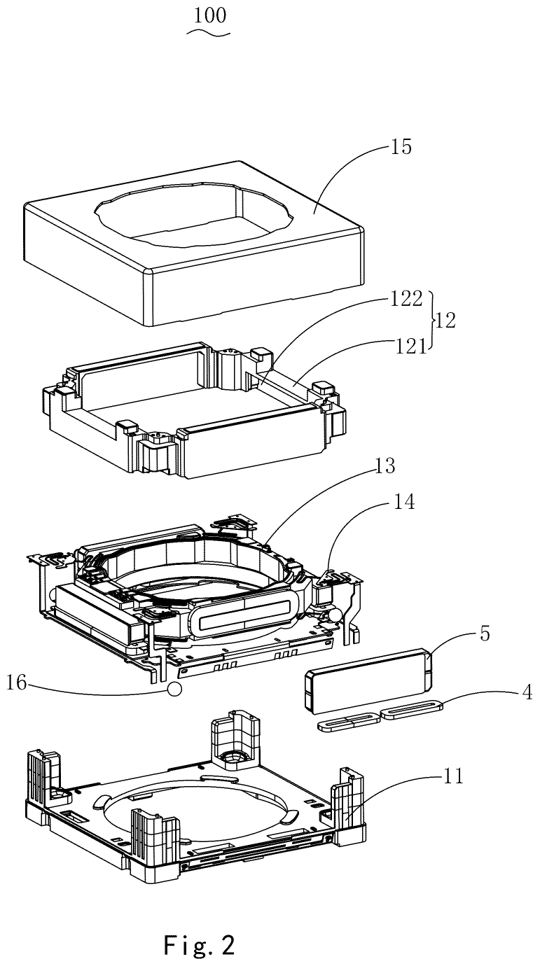

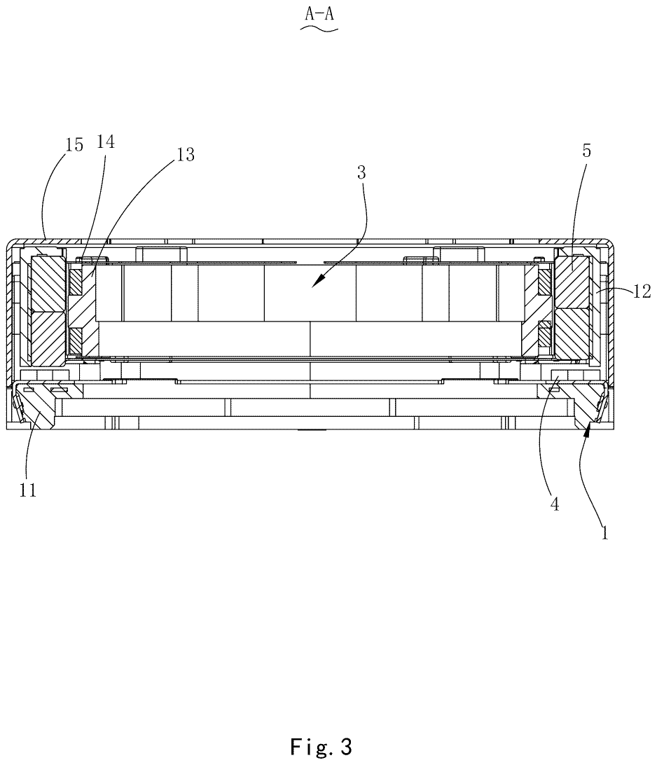

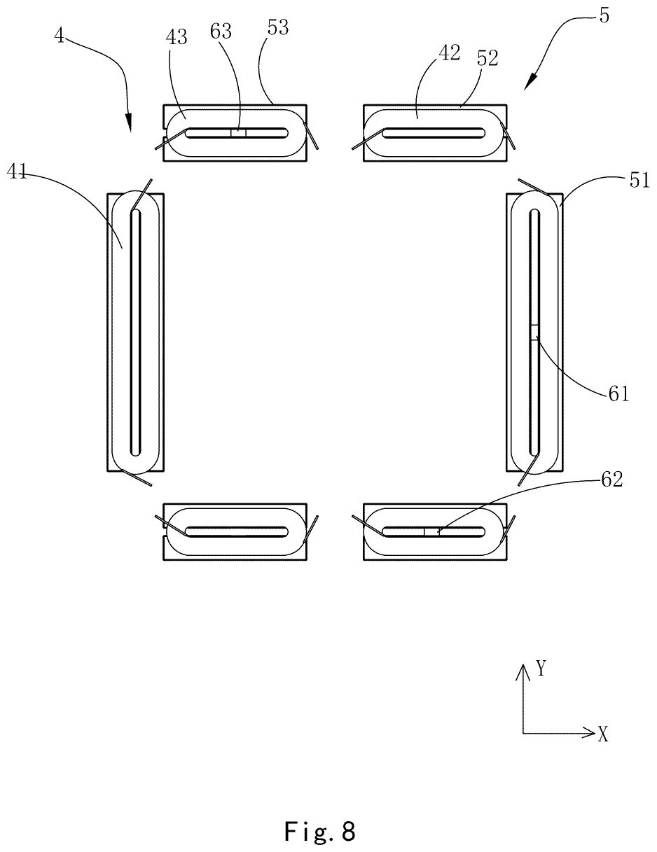

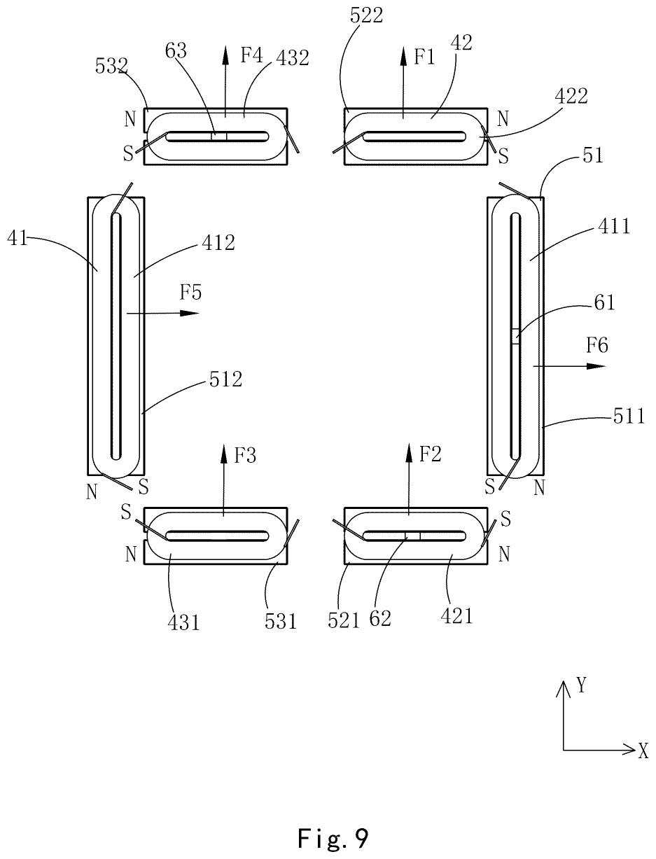

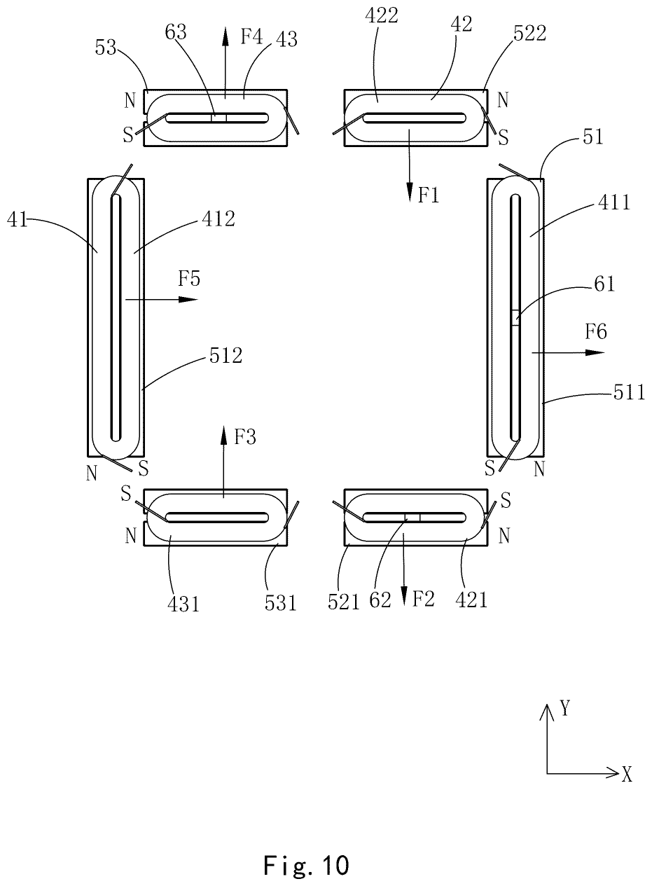

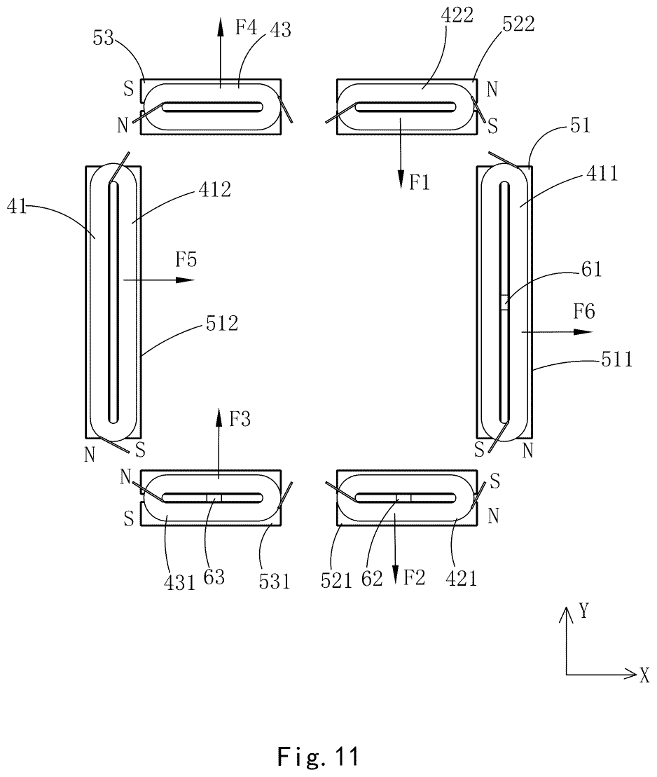

Referring to FIGS. 1-3 and 8-11, there is provided an image stabilization driving apparatus 100 configurable to drive an optical module to perform an image stabilization motion, the optical module having an optical axis (Z-axis), the image stabilization driving apparatus 100 comprising an image stabilization static part 1, an image stabilization moving part 3 movably supported on the image stabilization static part 1, coil groups 4, magnet groups 5, and drivers 6, the optical module being affixed to the image stabilization moving part 3.

In this implementation, the image stabilization static part 1 comprises a base 11 and a housing 15 which is affixed at the base 11 and defines an accommodation space together with the base 11; the image stabilization moving part comprises a support frame 12 defining a receiving space; the image stabilization driving apparatus 100 further comprises a support member 16 that suspends the support frame 12 movably in the accommodation space; the optical module is affixed to the support frame 12; and the coil groups 4 and the magnet groups 5 interact to drive the support frame 12 to move. Optionally, the support member 16 comprises a plurality of balls positioned on the base 11. In this implementation, the support frame 12 comprises a frame body 121 of a rectangular shape and a clearance recess 122 defined by a recessed sidewall of the frame body 121; the magnet groups 5 are mounted in the clearance recess and positioned, along the optical axis, opposite and spaced apart from the coil groups 4 mounted at the base 11; and the frame body 121 is movably supported on the base 11. The image stabilization driving apparatus 100 further comprises a holder 13 positioned in the support frame 12; a lens may be set in the holder 13; the holder 13 is elastically suspended in the support frame 12 via an elastic member 14. Optionally, the coil groups 4 may be affixed to the support frame 12 and the magnet groups 5 may be affixed to the base 11, the magnet groups 5 being positioned opposite and spaced apart from the magnet groups 4 along the optical axis direction; the coil groups 4 and the magnet groups 5 interact to produce an electromagnetic force driving the support frame 12 to move, while bringing the holder 13 also to move; and the drivers 6 are mounted at the image stabilization static part 1, the drivers 6 being operable to control actuating directions of the coil groups 4.

The coil groups 4 comprise a first coil group 41, a second coil group 42, and a third coil group 43 which are located in a same plane, the first coil group 41 including at least two coils positioned oppositely in a spaced apart manner along a first direction, the second coil group 42 and the third coil group 43 each including at least two coils positioned oppositely in a spaced apart manner along a second direction; the second coil group 42 and the third coil group 43 are positioned oppositely in a spaced apart manner along the first direction; the first direction and the second direction are perpendicular to each other and both perpendicular to the optical axis (Z-axis). In this implementation, the first direction is defined as a horizontal X-axis direction, and the second direction is defined as a horizontal Y-axis direction.

The magnet groups 5 comprise a first magnet group 51 positioned opposite and spaced apart from the first coil group 41, a second magnet group 52 positioned opposite and spaced apart from the second coil group 42, and a third magnet group 53 positioned opposite and spaced apart from the third coil group 43. Magnets in the first magnet group 52 are positioned at opposite sides of the support frame 12 along the first direction, magnets in the second magnet group 52 are positioned opposite the magnets in the third magnet group 53, and the second magnet group 52 and the third magnet group 53 are both positioned on a side surface of the support frame 12 along the second direction. The magnets in the first magnet group 51 are positioned at one side of the first coil group 41 and spaced apart from one another so that the first coil group 41 is located within a magnetic field of the first magnet group 51; the magnets in the second magnet group 52 are positioned at one side of the second coil group 42 and spaced apart from one another so that the second coil group 42 is located within a magnetic field of the second magnet group 52; and the magnets in third magnet group 53 are positioned at one side of the third coil group 43 and spaced apart from one another so that the third coil group 43 is located within a magnetic field of the third magnet group 53.

The drivers 6 comprise a first driver 61 set corresponding to the coils in the first coil group 41, a second driver 62 set corresponding to the coils in the second coil group 42, and a third driver 63 set corresponding to the coils in the third coil group 43; the first driver 61 is configurable to generate a first actuating signal to drive the first coil group 41 and the first magnet group 51 to interact, producing a first actuating force in the first direction to drive the image stabilization moving part 3 to move in the first direction; the second driver 62 is configurable to generate a second actuating signal to drive the second coil group 42 and the second magnet group 52 to interact to produce a second actuating force, and the third driver 63 is configurable to generate a third actuating signal to drive the third coil group 43 and the third magnet group 53 to interact to produce a third actuating force, directions of the second actuating force and the third actuating force being angled relative to the direction of the first actuating force. The second actuating force and the third actuating force co-act to drive the image stabilization moving part 3 to move along the second direction, or the second actuating force and the third actuating force co-act to drive the image stabilization moving part 3 to rotate about the optical axis while moving along the second direction, thereby implementing image stabilization and image stabilization correction in the second direction.

In this implementation, the first driver 61 is operable to control the first coil group 41 and the first magnet group 51 to interact to perform image stabilization control in the X-axis direction; the second driver 62 is operable to control the second coil group 42 and the second magnet group 52 to interact to perform image stabilization control in the Y-axis direction; and the third driver 63 is operable to control the third coil group 43 and the third magnet group 53 to interact to perform image stabilization control in the Y-axis direction.

Optionally, the first driver 61, the second driver 62, and the third driver 63 are driving ICs (integrated circuits), respectively.

In this implementation, the first coil group 41 comprises a fifth actuating coil 411 and a sixth actuating coil 412 which are positioned at two opposite sides of the image stabilization static part 1 along the first direction, respectively; the first magnet group 51 comprises a fifth magnet 511 and the sixth magnet 512 which are positioned facing each other; the fifth actuating coil 411 and the sixth actuating coil 412 are positioned directly facing and spaced apart from the fifth magnet 511 and the sixth magnet 512, respectively; when the first driver 61 works, the fifth actuating coil 411 and the sixth actuating coil 412 generate a fifth tractive force F5 and a sixth tractive force F6 in the first direction, respectively. A resultant force of the fifth tractive force F5 and the sixth tractive force F6 is referred to as the first actuating force, and the magnitudes and directions of the fifth tractive force F5 and the sixth tractive force F6 may be different; the first actuating force drives the support frame 12 to bring the holder 13 to move in the first direction; as such, the image stabilization driving apparatus realizes image stabilization in the first direction.

In this implementation, the second coil group 42 comprises a first actuating coil 421 and a second actuating coil 422 positioned at two opposite sides of the base 11 along the second direction, respectively; the third coil group 43 comprises a third actuating coil 431 and a fourth actuating coil 432 which are positioned at two opposite sides of the image stabilization static part 1 along the second direction, respectively; the first actuating coil 421 and the third actuating coil 431 are positioned at a same side; the second magnet group 52 comprises a first magnet 521 and a second magnet 522 which are set corresponding to the first actuating coil 421 and the second actuating coil 422, respectively; and the third magnet group 53 comprises a third magnet 531 and the fourth magnetic 532 which are set corresponding to the third actuating coil 431 and the fourth actuating coil 432, respectively.

In this implementation, the first actuating coil 421, the second actuating coil 422, the third actuating coil 431, and the fourth actuating coil 432 are energized to produce a first tractive force F1, a second tractive force F2, a third tractive force F3, and a fourth tractive force F4 in the second direction, respectively. A resultant force of the first tractive force F1 and the second tractive force F2 is referred to as the second actuating force, and a resultant force of the third tractive force F3 and the fourth tractive force F4 is referred to as the third actuating force. The directions and magnitudes of the first tractive force F1 and the second tractive force F2 may be identical or may be different; the directions and magnitudes of the third tractive force F3 and the fourth tractive force F4 may be identical or may be different.

In this implementation, in a case that the second actuating force and the third actuating force are in a same direction or the second actuating force and the third actuating force are in opposite directions while their magnitudes are different, and the directions of the second actuating force and the third actuating force are both perpendicular to the direction of the first actuating force, the second actuating force and the third actuating force co-act to drive the image stabilization moving part to move in the second direction, whereby the image stabilization driving apparatus realizes image stabilization in the Y-axis.

In this implementation, in a case that the second actuating force and the third actuating force are in a same direction or the second actuating force and the third actuating force are in opposite directions while their magnitudes are different, and the directions of the second actuating force and the third directing force both extend at an acute angle relative to the direction of the first actuating force, the second actuating force and the third actuating force co-act to drive the image stabilization moving part to rotate about the optical axis to correct the direction of image stabilization motion of the image stabilization driving apparatus so that the image stabilization moving part finally moves along the second direction, which realizes image stabilization in the Y-axis.

In this implementation, distribution of the magnetic poles of the magnets in the second magnet group 52 corresponding to the second driver 62 is opposite to distribution of the magnetic poles of the magnets in the third magnet group 53 corresponding to the third driver 63.

Specifically, in this implementation, when the second driver 62 and the third driver 63 are positioned diagonally on the support frame 12, i.e., the second driver 62 and the first magnet 521 are positioned facing each other, the third driver 63 and the fourth magnet 532 are positioned facing each other or the second driver 62 and the second magnet 522 are positioned facing each other, and the third driver 63 and the third magnet 531 are positioned facing each other. The magnetic pole of the first magnet 521 is opposite to the magnetic pole of the second magnet 522, and the magnetic pole of the third magnet 531 is opposite to the magnetic pole of the fourth magnet 532. In a case that the second driver 62 and the third driver 63 are positioned at a same side of the support frame 12, i.e., the magnetic pole of the first magnet 521 is identical to that of the second magnet 522, the magnetic pole of the third magnet 531 is identical to that of the fourth magnet 532, and the magnetic pole of the first magnet 521 is opposite to that of the third magnet 531.

In this implementation, the magnetic pole of the fifth magnet 511 is opposite to that of the sixth magnet 512.

### Second Implementation

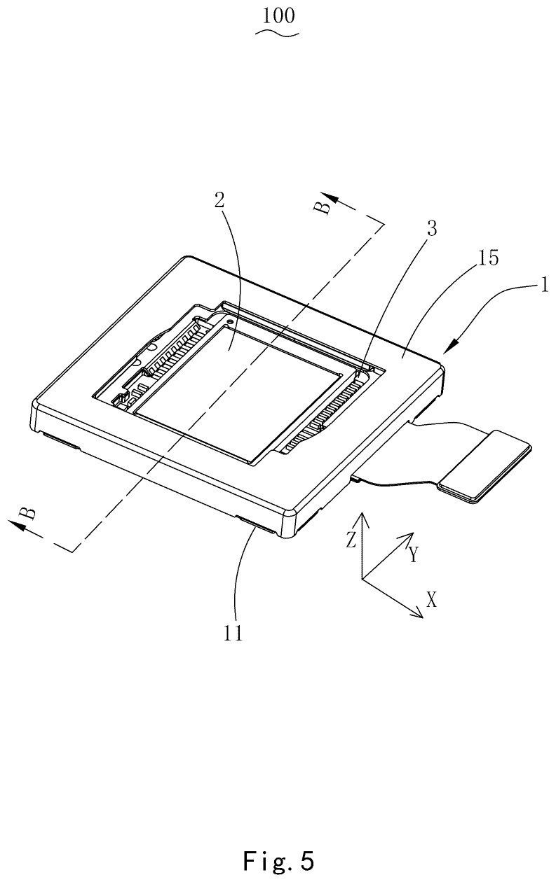

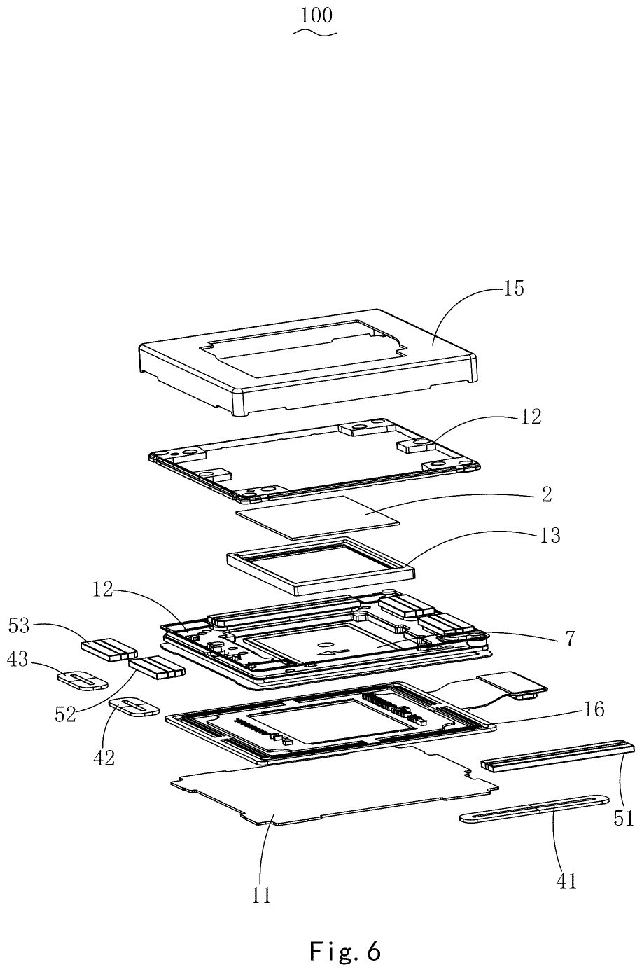

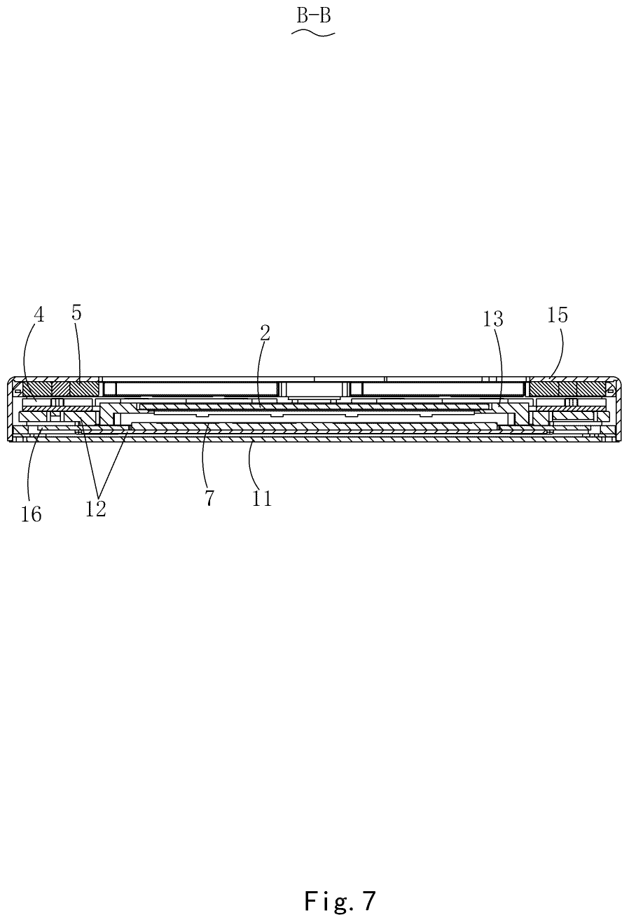

The second implementation has a structure substantially identical to the first implementation, with a same technical effect produced. The difference lies in that the image stabilization driving apparatus 100 according to the second implementation performs image stabilization by driving an image sensor to move. Specifically, as illustrated in FIGS. 5-11, the present disclosure further provides an image stabilization driving apparatus 100 operable to drive an optical module to perform an image stabilization motion, the optical module having an optical axis (Z-axis), the image stabilization driving apparatus 100 comprising an image stabilization static part 1, an image stabilization moving part 3 which is movably supported on the image stabilization static part, coil groups 4, magnet groups 5, and drivers 6; the optical module is affixed to the image stabilization moving part 3; one of the coil groups 4 and the magnet groups 5 are affixed to the image stabilization static part 1, while the other one thereof are affixed to the image stabilization moving part 3.

In this implementation, the image stabilization static part 1 comprises a base 11 and a housing 15 which is affixed to the base 11 and defines an accommodation space together with the base 11; the image stabilization moving part 3 comprises a support frame 12 defining a receiving space, the image sensor 7 being affixed to the support frame 12. The image stabilization driving apparatus 100 further comprises a support member 16 which suspends the support frame 12 movably in the accommodation space. In this implementation, the coil groups 4 are affixed to the support frame 12, and the magnet groups 5 are affixed to the housing 15; optionally, the coil groups 4 are affixed to the housing 15, while the magnet groups 5 are affixed to the support frame 12. The coil groups 4 and the magnet groups 5 interact to drive the support frame 12 to move, bringing the image sensor 7 to move to thereby realize image stabilization. The magnet groups 5 are positioned opposite and spaced apart from the coil groups 4 along the optical axis; in this implementation, the drivers 6 are mounted to the support frame 12 and located in the coil groups 4, the drivers 6 being operable to control actuating directions of the coil groups 4. The image stabilization driving apparatus 100 further comprises a holder 13 positioned at the support member 16, the holder 13 being positioned surrounding the image sensor 7, an optical filter 2 corresponding to the image sensor 7 being also positioned on the holder.

Compared with conventional technologies, in the image stabilization driving apparatus according to the present disclosure, one of the coil groups and the magnet groups are affixed to the image stabilization static part, while the other one thereof are affixed to the image stabilization moving part, the magnet groups being positioned opposite and spaced apart from the coil groups, the coil groups and the magnet groups interacting to produce an electromagnetic force driving the coil groups or the magnet groups to move, the drivers being mounted to the housing, the drivers being operable to control actuating directions of the coil groups; the second coil group being positioned opposite and spaced apart from the third coil group along the first direction; the first direction and the second direction are perpendicular to each other and they are both perpendicular to the optical axis; the first driver is operable to generate a first actuating signal to drive the first coil group and the first magnet group to interact to produce an actuating force in the first direction, the second driver is operable to produce a second actuating signal to drive the second coil group and the second magnet group to interact to produce a second actuating force, and a third driver is operable to produce a third actuating signal to drive the third coil group and the third magnet group to interact to produce a third actuating force; directions of the second actuating force and the third actuating force are angled relative to the direction of the first actuating force; the second actuating force and the third actuating force co-act to drive the image stabilization moving part to move along the second direction to implement image stabilization in the second direction. Or, the second actuating force and the third actuating force co-act to drive the image stabilization moving part to rotate about the optical axis while moving along the second direction, which corrects movement of the image stabilization moving part offset from the initially designed path back to the second direction. This novel rotating image stabilization apparatus can realize image stabilization and image stabilization correction.

What have been described supra are only example implementations of the present disclosure. It is noted here that to a person of normal skill in the art, any modifications made without departing from the invention idea of the present disclosure shall fall within the scope of protection of the present disclosure.

I/We claim:

1. An image stabilization driving apparatus, which is configurable to drive an optical module to perform an image stabilization motion, the optical module having an optical axis, the image stabilization driving apparatus comprising an image stabilization static part, an image stabilization moving part movably supported on the image stabilization static part, coil groups, magnet groups, and drivers; the optical module being affixed to the image stabilization moving part; one of the coil groups and the magnet groups being affixed to the image stabilization static part while the other one thereof being affixed to the image stabilization moving part; the magnet groups being positioned opposite and spaced apart from the coil groups, the coil groups and the magnet groups interacting to generate an electromagnetic force driving the image stabilization moving part to move, the drivers being mounted at the image stabilization static part, the drivers being operable to control actuating directions of the coil groups, wherein:
the coil groups comprise a first coil group, a second coil group, and a third coil group, which are located in a same plane, the first coil group including at least two coils oppositely positioned in a spaced apart manner along a first direction, the second coil group and the third coil group each including at least two coils oppositely positioned in a spaced apart manner along a second direction, the second coil group being positioned opposite and spaced apart from the third coil group along the first direction, the first direction and the second direction being perpendicular to each other and both being perpendicular to the optical axis;
the magnet groups comprise a first magnet group positioned opposite and spaced apart from the first coil group, a second magnet group positioned opposite and spaced apart from the second coil group, and a third magnet group positioned opposite and apart from the third coil group;
the drivers comprise a first driver set corresponding to the coils in the first coil group, a second driver set corresponding to the coils in the second coil group, and a third driver set corresponding to the coils in the third coil group, the first driver being configurable to generate a first actuating signal to drive the first coil group and the first magnet group to interact to produce a first actuating force in the first direction driving the image stabilization moving part to move along the first direction, the second driver being configurable to generate a second actuating signal to drive the second coil group and the second magnet group to interact to produce a second actuating force, the third driver being configurable to generate a third actuating signal to drive the third coil group and the third magnet group to interact to produce a third actuating force, directions of the second actuating force and the third actuating force being angled to the direction of the first actuating force, the second actuating force and the third actuating force co-acting to drive the image stabilization moving part to move along the second direction, or the second actuating force and the third actuating force co-acting to drive the image stabilization moving part to rotate about the optical axis while moving along the second direction to implement image stabilization in the second direction.

2. The image stabilization driving apparatus according to claim 1, wherein in a case that the second actuating force and the third actuating force extend in a same direction or the second actuating force and the third actuating force extend in opposite directions while their magnitudes are different, and directions of the second actuating force and the third actuating force being both perpendicular to the direction of the first actuating force, the second actuating force and the third actuating force co-act to drive the image stabilization moving part to move in the second direction.

3. The image stabilization driving apparatus according to claim 1, wherein in a case that the second actuating force and the third actuating force extend in a same direction or the second actuating force and the third actuating force extend in opposite directions while their magnitudes are different, and directions of the second actuating force and the third actuating force extend at an acute angle relative to the direction of the first actuating force, the second actuating force and the third actuating force co-act to drive the image stabilization moving part to rotate about the optical axis to correct an image stabilization movement direction of the image stabilization driving apparatus so that the image stabilization moving part moves in the second direction.

4. The image stabilization driving apparatus according to claim 1, wherein magnitudes and directions of actuating forces between different coils in a same coil group among the first coil group, the second coil group, and the third coil group are identical or different.

5. The image stabilization driving apparatus according to claim 1, wherein distribution of magnetic poles of magnets in the second magnet groups corresponding to the second driver is opposite to distribution of magnetic poles of magnets in the third magnet group corresponding to the third driver.

6. The image stabilization driving apparatus according to claim 5, wherein the second coil group includes a first actuating coil and a second actuating coil which are positioned at two opposite sides of the image stabilization static part along the second direction, respectively, and the third coil group includes a third actuating coil and a fourth actuating coil which are positioned at two opposite sides of the image stabilization static part along the second direction, respectively, the first actuating coil and the third actuating coil being located at a same side; the second magnet group includes a first magnet and a second magnet which are set corresponding to the first actuating coil and the second actuating coil, respectively, and the third magnet group includes a third magnet and a fourth magnet which are set corresponding to the third actuating coil and the fourth actuating coil, respectively;
the second driver is set in the first actuating coil or the second actuating coil, and the third driver is set in the third actuating coil or the fourth actuating coil.

7. The image stabilization driving apparatus according to claim 6, wherein in a case that the second driver and the third driver are diagonally located, a magnetic pole of the first magnet is opposite to a magnetic pole of the third magnet, a magnetic pole of the third magnet is opposite to a magnetic pole of the fourth magnet, and the magnetic pole of the first magnet is identical to the magnetic pole of the third magnet.

8. The image stabilization driving apparatus according to claim 6, wherein in a case that the second driver and the third driver are located at a same side, a magnetic pole of the first magnet is identical to a magnetic pole of the second magnet, a magnetic pole of the third magnet is identical to a magnetic pole of the fourth magnet, and the magnetic pole of the first magnet is opposite to the magnetic pole of the third magnet.

9. The image stabilization driving apparatus according to claim 1, wherein the image stabilization static part comprises a base and a housing which is affixed to the base and defines an accommodation space together with the base, the image stabilization moving part comprises a support frame defining a receiving space, and the image stabilization driving apparatus further comprises a support member that suspends the support frame movably in the accommodation space, the optical module being affixed to the support frame, the coil groups and the magnet groups interact to drive the support frame to move.
